(19) United States
(12) Patent Application Publication
(10) Pub. No.: US 2025/0060064 A1
(43) Pub. Date: Feb. 20, 2025

(54) PIPELINE PIG WITH PRESSURE-EQUALIZING TRANSMITTER CAVITY SYSTEM

(71) Applicant: TDW Delaware, Inc., Wilmington, DE (US)

(72) Inventors: Charles G. Boellstorff, Tulsa, OK (US); William C. Keenan, Broken Arrow, OK (US); Michael Johnston, Glenpool, OK (US); Joshua D. Mitchell, Broken Arrow, OK (US)

(21) Appl. No.: 18/708,338

(22) PCT Filed: Sep. 9, 2022
(86) PCT No.: PCT/US2022/043075

§ 371 Date: May 8, 2024

Related U.S. Application Data
(60) Provisional application No. 63/340,303, filed on May 10, 2022.

(51) Int. Cl. F16L 55/40

(52) U.S. Cl. CPC F16L 55/40

(57) ABSTRACT

Embodiments of a pipeline pig (10) of this disclosure and method of its use include a pressure-equalizing transmitter cavity system. Excluding sensors(S) and other electronic circuitry, the pipeline pig may be an all polyurethane pig. A plug (15) located at the rearward end (41) of the transmitter cavity (13) includes a passageway (25) that permits pipeline product to flow into the transmitter cavity. The plug is received by a flange (17) which may have a different harness than that of the plug. When in an intended use, the pipeline pig is inserted into the pipeline at one end and retrieved from the pipeline at another end. As the pipeline pig traverses the pipeline under differential pressure, pipeline pressure and temperature data may be collected and the location of the pipeline pig may be tracked. Pressure within the transmitter cavity is equalized with that of the pipeline product flow.

### BACKGROUND

This disclosure is in the field of pipeline pigs and, more specifically, pipeline pigs containing a transmitter cavity.

Pipeline pigs, which may be comprised of foam or hard urethane or steel body (mandrel) are used throughout the lifecycle of a pipeline. Common applications of foam pipeline pigs include proving passage, removing solids and wax, and dewatering pipelines. Hard urethane and mandrel-style pipeline pig applications include batching product, cleaning, wax removal, proving passage, and scale removal.

A foam pig's ability to transverse large obstructions and be outfitted with different accessories such as bristles and raised polyurethane knobs makes foam pigs a low-risk, low-cost item that can be utilized when unknowns or specific requirements exist. In addition, if a foam pig were to become lodged, differential pressure across the pig can be increased so the foam pig either moves past the obstruction or is broken into smaller pieces that can move past the obstruction. In either case, a customer's product flow is maintained and removal services such as digging and pipe cutting are not necessary.

Hard urethane pigs have many of the same advantages of foam pigs but are more rugged than foam pigs. The hard urethane pigs include the types of cups and discs found on steel body pigs and, therefore, provide improved sealing performance relative to foam pigs. Steel body pigs may have more difficulty traversing large obstructions or bends than either foam or hard urethane pigs but the number and type of cups and discs can be modified as needed. The cups and discs may also be replaced, making the pig reusable. Brushes, transmitter cavities, and magnetic inspection devices also may be added.

When operators run a pig in their pipelines, they desire to know its location. This can be accomplished through the use of pressure and flow data along the pipeline; signaling devices that are affixed (temporarily or permanently) to the pipeline and trigger when a pig passes them; or through a transponder attached to the pig and a transceiver outside the pipeline; or any combination of these methods.

Current transmitter cavities on the market either include some form of bolt/nut design for access or a plastic, ridged, cap or plug. Examples include Pipeline Pigging Products foam pig with cavity option for housing electronic tracking transmitter (solid flange bolted to rear of pig); Quality Polly Pig transmitter cavity foam squeegee and Apache Pipeline Products transmitter cavity foam pig (solid plug to seal cavity); and EP 2865457 A1 to Fras Technology AS (disclosing foam pig with transmitter cavity at forward end including a camera and lens). None of the prior art transmitter cavities are pressure equalizing.

### SUMMARY

Embodiments of a pipeline pig of this disclosure and method of its use include a pressure-equalizing transmitter cavity system. Excluding sensors and other electronic circuitry, the pipeline pig may be a foam pig or an all polyurethane pig. In other embodiments the pipeline pig may be of a kind known in the art to make use of urethane cups or discs arrayed about a central mandrel. The mandrel, which may be a metal, polyurethane, or polymer mandrel, includes a pressure-equalizing transmitter cavity system of this disclosure. When in an intended use, the pipeline pig is inserted into the pipeline at one end and retrieved from the pipeline at another end. As the pipeline pig traverses the pipeline under differential pressure, pipeline pressure and temperature data may be collected and the location of the pipeline pig may be tracked.

The pipeline pig includes a cavity located between a forward end and a rearward end of the pipeline pig, the cavity being arranged coaxial a central longitudinal centerline of the pipeline pig. The cavity may be sized to house at least one of a pressure sensor, a temperature sensor, a transmitter, and a receiver, or some combination thereof.

A flange including a central opening is located at a rearward end of the cavity. In some embodiments, the flange may be threaded and adhered to an inner wall of the cavity by way of a liquid polyurethane. The flange may have a first hardness. In other embodiments, where the pig includes a steel body, the flange may be mechanically fastened.

A plug, which is sized for engagement with the flange, includes a thru passageway. The passageway permit pipeline product to enter the cavity. The plug may be threaded and may have a second hardness different than that of the first hardness; When plug is engaged with the flange, the cavity is in fluid communication with the thru passageway of the plug. The plug and central opening may include threads. The threads may be arranged with one-to-many locking features and the plug may include a raised tab opposite its threaded end.

In some embodiments, the pig may include a pull rope molded into the foam body or hard urethane body and extending outward of the forward end pig.

In embodiments, a pipeline pig of this disclosure includes a cavity located between a forward end and a rearward end of the pipeline pig and arranged coaxial a central longitudinal centerline of the pipeline pig, the cavity having a forward and a rearward end, the forward end being a closed end; a flange located at the rearward end of the cavity, the flange including a central opening and having a first hardness; a plug sized for engagement with the central opening of the flange, the plug including a thru passageway and having a second hardness different than that of the first hardness; wherein, when the plug is engaged with the flange, the cavity is in fluid communication with the thru passageway of the plug.

In some embodiments, the flange is affixed to an inner wall of the cavity. The plug and the central opening of the flange may include threads complementary to one another. The cavity may house at least one sensor and at least one transponder The cavity, flange, and plug may comprise polyurethane. A pull rope may extend outward of the forward end of the pipeline pig.

In embodiments of a method of this disclosure, the method permits pressure-equalizing a transmitter cavity of a pipeline pig when the pipeline pig is traveling through an interior of a pipeline by way of differential pressure due to pipeline product flow. When in an intended use, the plug is engaged with the flange and the cavity is in fluid communication with the thru passageway of the plug. Pressure of the cavity is equalized with that of the pipeline product flow as a portion of the pipeline product flow fills the cavity during the traveling.

### BRIEF DESCRIPTION OF THE DRAWINGS

FIG. 1 is a cross-section view of an embodiment of a foam pig of this disclosure. The foam pig includes pressure-equalizing cavity. In other embodiments, the pig maybe a hard urethane or steel body pig, the pig including the pressure-equalizing cavity as well as urethane cups or discs arrayed about the pig. See e.g. FIG. 4.

FIG. 2 is an isometric view of the removable plug of FIG. 1. The plug includes a passageway that provides fluid communication between the cavity and pipeline product.

FIG. 3 is an isometric view of the threaded flange of FIG. 1.

FIG. 4 is cross-section view of an embodiment of a hard urethane pipeline pig of this disclosure including a pressure-equalizing cavity. In other embodiments the pig is a steel body pig including sealing cups or discs arranged about its mandrel. The mandrel includes the pressure-equalizing cavity.

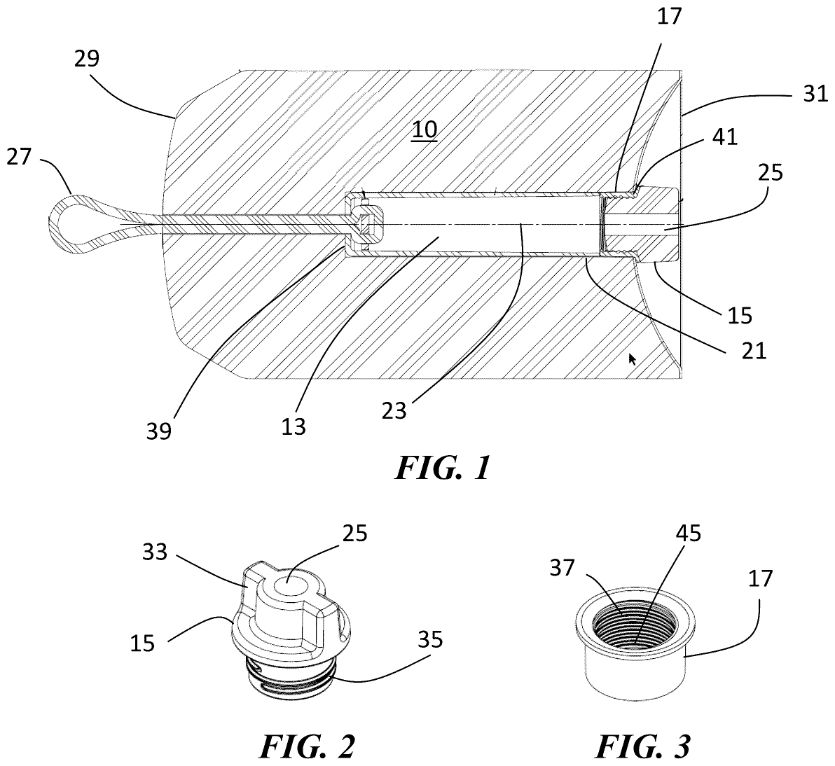

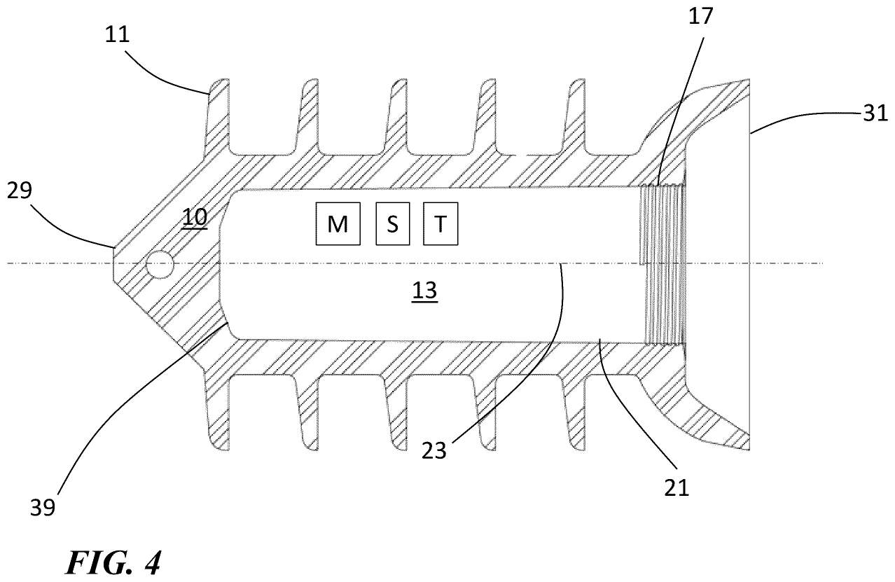

### ELEMENTS AND NUMBERING USED IN THE DRAWINGS AND DESCRIPTION

10 Pipeline pig
11 Sealing cups or discs
13 Cavity
15 Plug
17 Flange
21 Internal wall
23 Longitudinal centerline
25 Thru passageway through plug into cavity
27 Rope
29 Forward end of pig
31 Rearward end of pig
33 Tab
35 Threads of plug
37 Threads of flange
39 Closed forward end of cavity
41 Rearward end of cavity
45 Central opening sized to receive plug

### DETAILED DESCRIPTION

Referring to the drawings, embodiments of a pig 10 of this disclosure can be made of polyurethane foam and use polyurethane as both product and adhesive. In other embodiments, the pig 10 may comprise a hard urethane body or a steel body and include sealing cups or discs 11.

The pig 10 may have sizes and dimensions like that of T. D. Williamson, Inc. REDSKIN™ foam pigs (2 inches to 24 inches) (50 mm to 600 mm) or WHITESKIN foam pigs (2 inches to 42 inches) (50 mm to 1050 mm). Foam density may be low, medium, or high. In some embodiments, density is in a range of 2-3 lbs/ft³, 4-6 lbs/ft³, 7-9 lbs/ft³, and 2-9 lbs/ft³, there being sub-ranges and discrete values within these broader ranges. The pig 10 may be bullet-shaped and may include a molded-in pull rope 27 at its forward end 11 to assist in removal of the pig 10 from a pipeline.

In embodiments, the pig 10 includes a cavity 13 located between the forward and rearward ends 29, 31 and co-axial a longitudinal centerline 23 of the pig 10. In some embodiments, the cavity 13 is a polyurethane cavity molded as part of the foam or hard urethane pig 10.

Cavity 13 may contain one or more sensors S (e.g. pressure, temperature, flow) and transponders T, or some combination thereof, the sensors S and transponders T being of a kind known in the art. The cavity 13 may also include one or more microprocessors M and associated memory and software for use in connection with the sensors S and transponders T.

Unlike a bypass flow passageway, which allows pipeline product to flow thru a bypass flow passageway between the rearward end 31 to the forward end 29 of the pipeline pig 10, a cavity 13 of this disclosure is closed at its forward end 39, thereby preventing bypass flow through the cavity 13. (Embodiments of the pipeline pig 10 may be arranged for bypass flow but not through the cavity 13). The rearward end 41 of the cavity 13 remains open to pipeline product flow and pressure by way of thru passageway 25 of a plug 15.

Plug 15 is located at a rearward end 41 of the cavity 13. The plug 15 includes a passageway 25 that permits pipeline product to enter the cavity 13, thereby making the foam pig 10 pressure-equalizing. The plug 15 also serves as a removable access cover to the cavity 13. The plug 15 may be removed to access the cavity 13 for routine maintenance or re-configuration or replacement of one or more of its sensors, transponders, and microprocessors.

In embodiments, the plug 15 may include threads 35. The plug 15 may also include a raised tab 33 that is an integral part of the plug 15 to assist with its removal, and subsequent access to cavity 13. The tab 33 permits manipulation of the plug 15 without tools. Tool-free manipulation is helpful when an operator or technician is wearing personal protective equipment or when obstacles may impede removal

The plug 15 is received by s central opening 45 of a flange 17 located at the rearward end 41 of the cavity 13. The opening 45 is sized to receive the plug 15. Where the plug 15 is threaded, the opening 45 includes mating threads 37. The flange 17 may be a polyurethane, as may the plug 15. The flange 17 may include one-to-many cast locking features corresponding with those of the plug 15.

The flange 17 may be adhered to internal wall 21 of the cavity 13. In some embodiments, the flange 17 can adhere to different densities of polyurethane foam via liquid polyurethane. The flange 17 may include a modified thread that increases holding when tightened and allows for easier removal of the plug 15. In other embodiments, the flange 17 may be mechanically fastened to the pig 10, as would be the case with a steel body pig.

In some embodiments, the flange 17 has a first hardness and the plug 15 has a second hardness different than that of the first. Each hardness may be in a range of 75 to 95 shore. The first hardness may be greater than the second or less than the second. The difference in hardness helps to ensure the thread profile deforms for full engagement and helps to ensure removal of the plug 15 from the flange 17.

When in an intended use, pipeline products enters the cavity 13 by way of the passageway 25.

1. A pipeline pig (10) comprising:
a transmitter cavity (13) located between a forward end (29) and a rearward end (31) of the pipeline pig and arranged coaxial a central longitudinal centerline (23) of the pipeline pig, the transmitter cavity having a forward end (39) and a rearward end (41), the forward end being a closed end;
a flange (17) located at the rearward end of the cavity, the flange including a central opening (45) and having a first hardness;
a plug (15) sized for engagement with the central opening of the flange, the plug including a thru passageway (25) and having a second hardness different than that of the first hardness;
wherein, when the plug is engaged with the flange, the transmitter cavity is in fluid communication with the thru passageway of the plug.

2. The pipeline pig of claim 1, wherein, the flange is affixed to inner wall (21) of the transmitter cavity.

3. The pipeline pig of claim 1, wherein, the plug and the central opening of the flange include threads (35, 37) complementary to one another.

4. The pipeline pig of claim 1, further comprising, the transmitter cavity housing at least one sensor(S), at least one transponder (T), or at least one sensor and transponder.

5. The pipeline pig of claim 1, wherein, the transmitter cavity, flange, and plug comprise polyurethane.

6. The pipeline pig of claim 1, further comprising, a pull rope (27) extending outward of the forward end of the pipeline pig.

7. A method for pressure-equalizing a transmitter cavity of a pipeline pig when the pipeline pig is traveling through an interior of a pipeline by way of differential pressure due to pipeline product flow, the method comprising:
providing a pipeline pig (10) including:
a transmitter cavity (13) located between a forward end (29) and a rearward end (31) of the pipeline pig and arranged coaxial a central longitudinal centerline (23) of the pipeline pig, the transmitter cavity having a forward end (39) and a rearward end (41), the forward end being a closed end;
a flange (17) located at the rearward end of the transmitter cavity, the flange including a central opening (45) and having a first hardness;
a plug (15) sized for engagement with the central opening of the flange, the plug including a thru passageway (25) and having a second hardness different than that of the first hardness;
wherein, when the plug is engaged with the flange, the transmitter cavity is in fluid communication with the thru passageway of the plug.
the method further comprising, equalizing a pressure of the transmitter cavity with that of the pipeline product flow as a portion of the pipeline product flow fills the transmitter cavity during the traveling.

8. The method of claim 7, wherein, the flange is affixed to an inner wall (21) of the transmitter cavity.

9. The method of claim 7, wherein, the plug and the central opening of the flange include threads (35, 37) complementary to one another.

10. The method of claim 7, wherein, the transmitter cavity housing at least one sensor(S), at least one transponder (T), or at least one sensor and at least one transponder.

11. The method of claim 7, wherein, the transmitter cavity, flange, and plug comprise polyurethane.

12. The method of claim 7, wherein, the pipeline pig includes a pull rope (27) extending outward of the forward end of the pipeline pig.

13. The method of claim 7, further comprising:
inserting the pipeline pig at one end of a pipeline; and
retrieving the pipeline pig from another end of the pipeline.

14. The pipeline pig of claim 1, wherein the transmitter cavity has an inner wall (21) and the transmitter cavity adapted to house at least one of a sensor(S) and a transponder (T) and contain a pipeline product flow.

15. The pipeline pig of claim 14, the inner wall of the transmitter cavity running parallel to the central longitudinal centerline of the pipeline pig between the forward and rearward ends of the transmitter cavity.
